(19) United States
(12) Patent Application Publication
(10) Pub. No.: US 2003/0097789 A1
(43) Pub. Date: May 29, 2003

(54) Hydroponic growing device adapted for the growing and scientific study of arabidopsis thaliana

(76) Inventors: Laurent Corbesier, Sprimont (BE); Pierre Tocquin, Tilff (BE); Alexandra Pieltain, Tilff (BE); Emile Kurtem, Embourg (BE); Claire Perilleux, Angleur (BE)

Correspondence Address: JACOBSON HOLMAN PLLC, 400 SEVENTH STREET N.W., SUITE 600, WASHINGTON, DC, 20004, US

(21) Appl. No.: 10/096,648

(22) Filed: Mar. 14, 2002

(30) Foreign Application Priority Data
Nov. 23, 2001 (EP) 01204480.6

(51) Int. Cl. A01G 31/00

(52) U.S. Cl. 47/64

(57) ABSTRACT

A plant growing device comprising a container (1), characterised in that it contains a hydroponic growing medium (2), and is covered by a lid (3), supplied with perforations (4) for the supports (5) of said plants, in that said supports (5) are filled with agar (13).

### OBJECT OF THE INVENTION

The present invention concerns a hydroponic growing system as well as other means adapted for the growing and scientific study of small plants, particularly of Arabidopsis thaliana.

### TECHNOLOGICAL BACKGROUND AND STATE OF THE ART OF THE INVENTION

The development and growth of plants depend greatly on the nutrients they can find in their medium.

The massive use in agriculture of fertilisers to ensure the yield of the crops produces both economic and ecological problems. This is why a large number of researches in plant biology and in agronomy focus on the understanding of the mechanisms linked to the mineral nutrition of plants.

In this context the use of a limited number of model plants that serve as a support to a great part of the scientific community should allow a better integration of the results obtained by different groups working both at the level of the whole plant and at the level of the cell and the genes.

This trend also implies that the growing conditions used should be if not uniform at least comparable.

Arabidopsis thaliana is a small plant belonging to the family of Brassicaceae that has no specific agronomical interest. Nevertheless, some of its characteristics offer undeniable advantages for many researches in plant biology, particularly in genetics and molecular biology.

Amongst these characteristics are:

the small size, allowing its culture in small spaces,

the easy growth and the possibility of collecting many of seeds,

the rapid development (about 6 weeks from seeds to seeds),

the small size of the genome, of which more than 95% of the sequence is known to date,

the availability of a great number of mutants, and

the easiness of its genetic transformation.

Such advantages have made it a model organism for the genetic and molecular studies of plants and favoured the generalisation of its use in the scientific community. Proof of this is that the number of scientific publications concerning Arabidopsis thaliana is more important than those related to species with agronomical interest such as tobacco, corn, wheat, or rice.

However, Arabidopsis thaliana presents some disadvantages for physiological studies. For example, its small size and its rosette shape are obstacles for its use in hydroponics, the only growing system adequate for the observation or the harvest of roots and the study of mineral nutrition.

Hydroponics consists in growing plants directly on a liquid medium containing all the nutrients that are necessary for their growth. This principle is simple, well known, and used since many years in various fields such as agronomical production, scientific research, etc.

The major advantages of this technique are that the mineral nutrition can be controlled for each of the nutritients and that the study of the root system is made possible by the suppression of the solid substrates such as mould or sand.

Although in theory this growing method is simple, its implementation needs efforts of adaptation both to the particularities of the species to which it is intended (size, shape, growing conditions . . . ) and to the purpose of this culture (ornamental growing, mass production, scientific research . . . ).

On the other hand, independently of these adjustments, hydroponic growing is subject to specific constraints (contamination of the nutritional solution with algae or other micro-organisms, aeration of the nutritional solution, necessity to renew the solutions, etc.).

### OBJECT OF THE INVENTION

The present invention intends to supply an improved hydroponic growing system particularly adapted to small plants. This system is aimed particularly to scientific studies using Arabidopsis thaliana.

Another objective of the present invention is to supply such a system together with reducing the risks of contamination of the nutritional solution with algae or other micro-organisms, and providing a simple and cheap device.

A last objective of the present invention is to supply a simple standard device that can easily be produced in a uniform way, said standard device allowing manipulation of small plants such as Arabidopsis thaliana in identical or comparable conditions by different scientific groups.

### CHARACTERISTICS OF THE INVENTION

The present invention concerns a growing device that combines advantageously a hydroponic growing medium and an inert support (for example, agar) for plants.

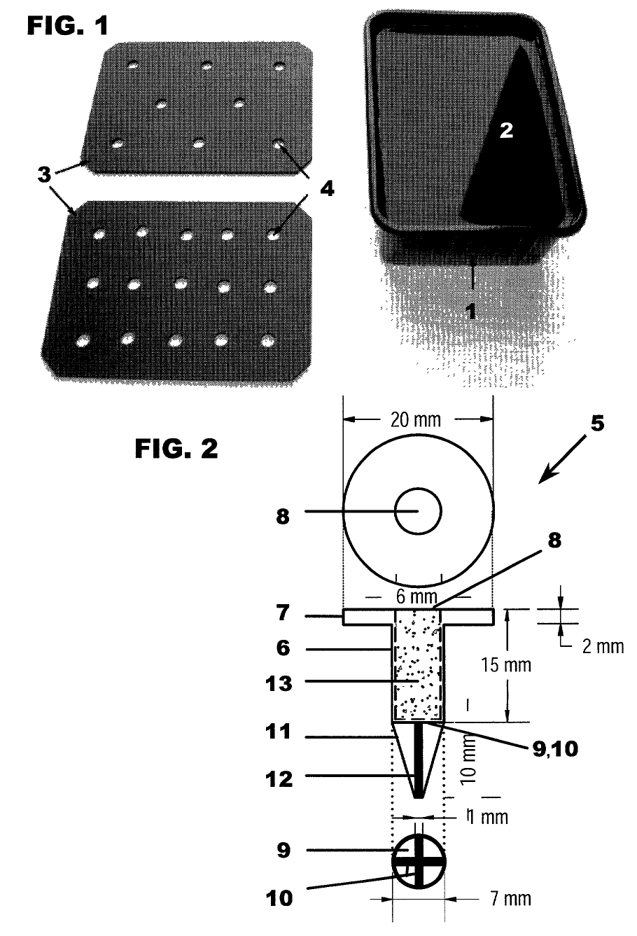

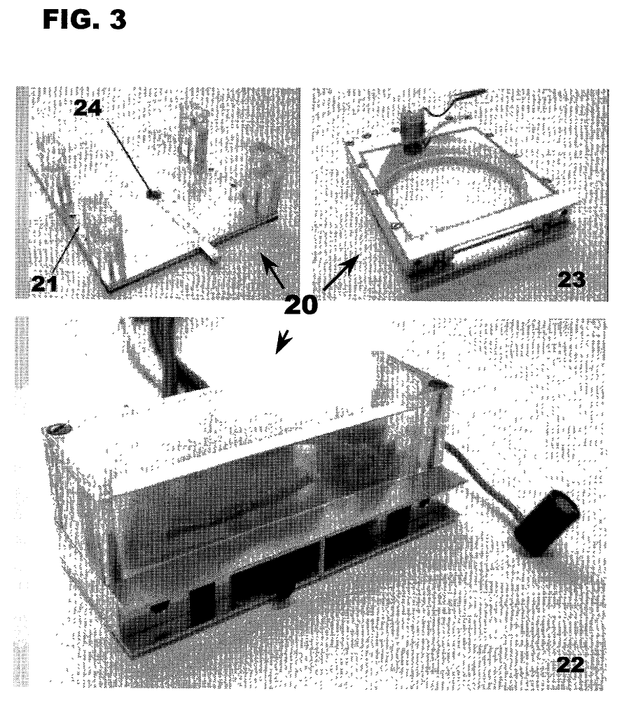

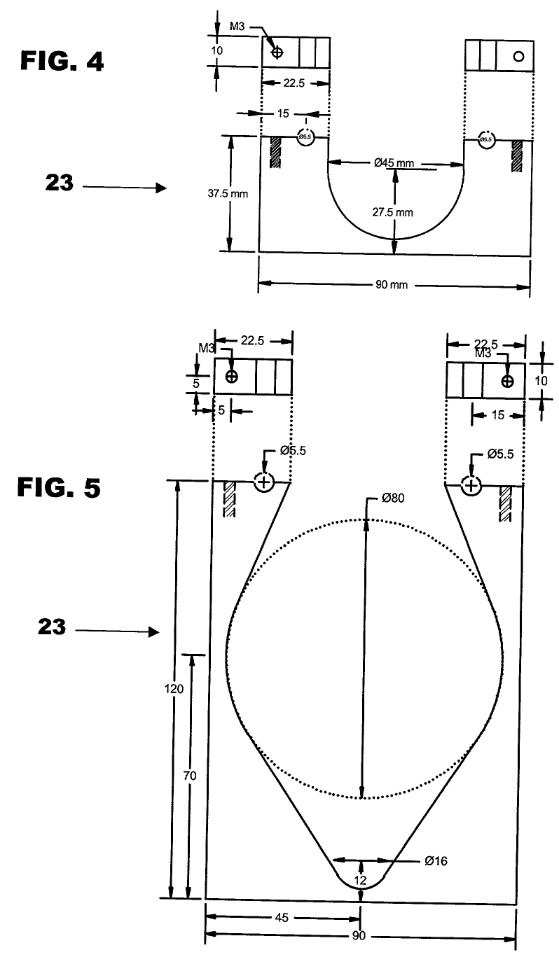

Such a device represented in FIGS. 1 and 2 is made with inert and opaque materials (for example, black PVC), preferably dyed in the mass in order to eliminate the risk of flaking of a paint that could then contaminate the nutritional solutions, at the same time guaranteeing a longer life span of each element of the device.

Said device comprises a container 1 containing a hydroponic growing medium 2 and sometimes connection systems allowing the connection of the containers and/or the continuous renewal of the hydroponic growing mediums (not represented).

Said container 1 comprises a moveable lid or plate 3 supplied with perforations or holes 4 able to receive the supports 5 of said plants.

Said supports 5 are composed of a tubular body 6 having preferably a cylindrical form or another configuration appropriate for said perforation 4. They are supplied at their top end with a neck 7, preferably of an essentially cylindrical form surrounding the top opening 8 of the tubular body 6 in order to keep it in the corresponding perforation 4. The other end of the tubular body 6 also comprises a bottom opening 9 sometimes ended by a grid 10. Preferably, this grid 10 is formed by the intersection of two protuberances 11 and 12 prolonging the tubular body 6 (such as represented in FIG. 2).

Advantageously, for the growing of Arabidopsis thaliana and as represented in FIG. 2, the length of the tubular body 6 is about 15 mm, its diameter is about 7 mm, the diameter of the neck 7 is about 20 mm, and its thickness is about 2 mm. Preferably, the top and bottom openings (8 and 9) of the tubular body 6 are about 6 mm, the protuberances 11 and 12 forming the grid 10 at the bottom opening of the tubular body 6 have a thickness of about 1 mm.

According to the invention the support 5 of the plant is made in one piece by plastic injection in a mould or by any other conventional technique.

The tubular body 6 contains preferably an inert solid medium 13 (agar gel) of common use for growing plants. The use of agar allows to control the humidity at the germinating seed level and to have a non-contaminated and ideal inert support for the development of the seedling (particularly the roots) before it comes into contact with the growing liquid medium. Furthermore, the agar presents the advantage of being a soft support that allows the integral sampling of the plant without damage to the plant and at any time of its growth.

The device of the invention is particularly well adapted to a scientific use because it is modular and thus adaptable to any growing structure (incubator, air-conditioned chambers, greenhouses, etc.) but equally to any experimental need and allows notably the individual manipulation of the plants maintained on the support.

In fact, each container 1 is an experimental unit that can contain a variable number of plants (for example such as represented in FIG. 1, the device can support 1 to 44 plants) subjected to identical environmental and nutritional conditions.

Furthermore, inside each container 1 each plant develops on a moveable support 5. Each plant can then be at any time isolated from one container and replaced in this same container or in another. The same operation can be done for all the plants in a container simultaneously by manipulating the moveable lid 3 of the container.

Furthermore, the manipulation and transport of a container or a small group of containers are facilitated by its small size. This allows its integration to any growing structure but also to modify at one's choice the environmental conditions that the plants undergo when transferring them from one environment to another.

On the other hand, it is well understood that the device of the invention can be combined to other elements facilitating the assembly and maintenance of the growing such as canalisations, pumps, automatic filling systems of the supports 5, etc.

Finally, the device can be combined with an instrument for measuring the photosynthesis of a whole plant of Arabidopsis thaliana such as described below.

Photosynthesis is a basic metabolism of the life of plants. It ensures the conversion of light energy and carbon dioxide (CO₂) into sugar molecules that supply all the plant with the indispensable energy for the accomplishment of the multiple metabolic reactions necessary for its subsistence and its development.

Consequently, the study of photosynthesis is of major interest in agronomy and in plant biology research because its efficiency determines the yield of the grown species.

On the other hand, more recently, the need to study photosynthesis is reinforced by the growing interest that the scientific community brings to the problems of climatic changes. In fact, the main cause of these changes is a foreseeable and important increase of the amount of carbon dioxide in the atmosphere during the next century. Photosynthesis is then the main metabolism to be affected by this increase. Photosynthesis thus controls the general response of the plant to these environmental modifications. assemble a chamber allowing to keep a sufficient airtightness and to be able to precisely control the flux of air.

On the other hand, the light intensity that reaches the leaves can be more difficult to estimate as well as the leaf surface contained in the chamber.

Finally, the bigger the volume of the chamber, the longer the measurement requires to be performed until it becomes practically impossible.

In this context Arabidopsis thaliana is an ideal plant to carry out this type of measurement: it is small and of simple form (rosette), which thus presents little problems for controlling the air flux or the estimation of the quantity of light received by the plant and its leaf surface.

However, being largely used throughout the world, this model plant is grown in very varied growing systems: in pots, boxes, on mould or in hydroponics . . . . It is then necessary to be able to have a chamber that is independent of growth conditions used. On the other hand, the whole life cycle of this plant should be studied. Given that the precision and rapidity of the measurements are weaker the bigger the volume of the chamber and the surface of the plant are, a chamber designed for adult plants will be inefficient for the measurement of young plants.

A second aspect of the present invention is related to a device 20 allowing the measurement of the photosynthesis of a whole small plant, of the Arabidopsis thaliana type, whatever the stage of its growth.

This device 20 comprises three pieces made from materials which characteristics are compatible with the type of measurements to be done (weak adsorption of water vapour and carbon dioxide, no modification of the quality or quantity of light reaching the plant . . . ):

a rigid base 21 of very low thickness (of about 3 mm or less) that fits between the plant and the substrate in order to isolate it from the inside of a chamber 23,

a central unit 22 containing all the electronic and mechanical equipment required for the functioning of the chamber,

In this context, techniques are developed to measure in vivo—in a non-destructive way—the photosynthesis of plants on the grounds (fields, forests . . . ) or in the laboratory.

In general, a part of a leaf or a whole leaf is isolated in a gas tight chamber—generally named “chamber”—made airtight to the outside atmosphere. A flux of air is produced in this chamber and a device allowing the measurement of the quantity of carbon dioxide is used to analyse the air before and after it has passed over the surface of the leaf. The difference between these 2 measurements is then revealing of the photosynthetic activity (fixation of CO₂) of the leaf enclosed in the chamber.

The chamber is generally designed to enclose only a portion of the leaf. It is then often of a small size and volume, which ensures the accomplishment of precise and rapid measurements. On the other hand, as the leaf fills the chamber's surface the leaf surface used in the measuring is directly known (surface of the chamber).

This principle implies that this type of chamber is usable for a large number of plants, the only restraint being the size of the leaf to be used.

However, this type of measurements has some disadvantages. In fact, all the leaves of a same plant do not present the same photosynthetic performances: their age, the environmental conditions in which they are (shade, sunlight . . . ) or even the diseases that can affect them are also parameters that can modify their photosynthesis.

Sometimes even the photosynthetic activity can vary in the same leaf: this is notably the case of the monocotyledons, where cells are older the nearer to the tip of the leaf they are.

It seems that if this type of chamber allows precise and rapid measurements it is nevertheless necessary to reproduce them several times on different leaves to asses the global situation of the plant.

There is then an undeniable advantage in being able to carry out directly the measurement of the photosynthetic activity of a whole plant. Nevertheless, in this case numerous obstacles have to be overcome: the plants of an important size or of a complex form make it difficult to

a chamber 23 that is a container whose size and volume are adapted at the same time to the central unit 22, to its base 21, and to the size of the plant to be studied, particularly Arabidopsis thaliana.

The base 21 is advantageously supplied with a perforation 24 allowing the insertion of the stem of the plant. Furthermore, the base 21 allows to make the device 20 completely independent of the growing system used, at the same time forms a complete isolation of the plant from its substrate.

The objective of the invention is also related to a kit for the quantification of the photosynthesis comprising the device 20 of the invention as well as a set of different chambers of increasing size and volume, adapted to the central unit 22 and to the base 21, and that may be adapted to the size of the plant.

Furthermore, the central unit 22 and the chamber 23 are designed in a way to ensure a homogeneous flux of air and of a controled force in order to ensure reliable and reproducible measurements. To this end, this device may comprise other elements such as mini-fans ensuring an efficient and uniform flux of the air in the chamber.

1. A plant growing device comprising a container (1) containing a hydroponic growing medium (2) covered by a lid (3), characterised in that said lid is supplied with perforations (4) for supports (5) of said plants and in that said supports (5) are filled with an inert support (agar) (13).

2. A device according to claim 1, characterised in that the container (1) is filled with a hydroponic growing medium (2) up to a level that allows a contact between the inert support (13) present in the support (5) and the hydroponic growing medium (2).

3. A device according to claims 1 or 2, characterised in that said plant supports (5) are composed of a neck (7) surrounding the top opening (8) of a tubular body (6) and comprising a bottom opening (9) optionally ended by a grid (10).

4. A device according to claim 3, characterised in that the grid (10) is formed by the intersection of two protuberances (11 and 12) in pointed form prolonging the tubular body (6).

5. A device according to any of the preceeding claims 1 to 4, characterised in that the tubular body (6) and the neck (7) present a cylindrical form.

6. A device according to any of the claims 1 to 5, manufactured from an inert and opaque material.

7. A device according to any of the claims 3 to 6, characterised in that the length of the tubular body (6) is less that 20 mm, preferably about 15 mm, in that its diameter is less than 10 mm, preferably about 7 mm and in that the top and bottom openings (8 and 9) of the tubular body (6) are about 6 mm.

8. The use of the device according to any of the preceeding claims 1 to 7 for the development and growing of small plants.

9. The use according to claim 8, characterised in that the small plant is Arabidopsis thaliana.
